(19) United States
(12) Patent Application Publication
(10) Pub. No.: US 2011/0272370 A1
(43) Pub. Date: Nov. 10, 2011

(54) Storage and display device for articles

(76) Inventors: Francis P. McDonald, Burbank, CA (US); Anthony E. Garcia, Stevenson Ranch, CA (US)

(21) Appl. No.: 13/066,596

(22) Filed: Apr. 18, 2011

Related U.S. Application Data
(60) Provisional application No. 61/342,667, filed on Apr. 16, 2010.

(51) Int. Cl. A47B 81/00; G09F 3/00

(52) U.S. Cl. 211/85.7; 40/299.01

(57) ABSTRACT

An device for the storage and display of various articles, in particular toys and stuffed animals wherein the articles can either be stored within the interior or placed within openings in device so that the articles can displayed.

### CROSS-REFERENCE TO RELATED APPLICATIONS

This application claims the benefit of U.S. Provisional application 61/342,667 filed 6 Apr. 2010 which is expressly incorporated by reference herein.

### BACKGROUND

In today's society, children end up receiving many type of toys and playthings. Their tendency is to use pay with their various toys on the floor, on their beds and all about the house. As is typical, children are not very inclined to clean up after playing. This creates conflict between the children and caregivers.

In an attempt to encourage children to clean up and put their toys away, various type of storage devices have been developed These can included devices which are strictly storage and those that combine a certain amount of display and entertainment aspects as well as storage aspects.

For example, U.S. Pat. No. 6,059,122 discloses a generally flat base which has various openings which can hold stuffed toys. It is designed to be leaned against a wall or mounted suspended against a wall so that the hind portion of the stuffed animals can extend past the back surface of the base and the front portion of the stuffed animal visible from the front of the flat base.

A similar device is disclosed in U.S. Pat. No. 5,813,545. However this device is designed to have two flat surfaces mounted essentially vertically so that the two surfaces support each on a base. The two flat surfaces contain a plurality of holes which are designed to support a figurine with displaceable stuffing.

The limitation of these devices is that the number of figurines or stuffed animals that can be stored is limited by the surface area of the flat surfaces. What is needed is a device that can both store articles within the openings in a front panel but also provided additional storage behind the front panel.

### BRIEF SUMMARY OF THE INVENTION

The instant invention provides a more or less enclosed area behind the front panel which contains a plurality of openings. The enclosed space provides storage space for stuffed animals that can be inserted through one of the openings and deposited within the enclosed space. In addition stuffed animals and the like can be easily positioned within the openings by molding the stuffing of the animal so that approximately one part of the toy hangs down on the front of the panel and the other part of the toy hangs down the back side of the front panel. The stuffed animals can also be easily be positioned to hang over the top opening of structure or openings provided in the structures forming the enclosed space behind the front panel.

### BRIEF DESCRIPTION OF THE SEVERAL VIEW OF THE DRAWINGS

A better understanding of the present invention will be realized from the detailed description which follows, taken in conjunction with the accompanying drawings in which:

FIG. 1 is a perspective front view of one embodiment of the invention;

FIG. 2 is a perspective back view of one embodiment of the invention;

FIG. 3 is a top view of one embodiment of the invention;

FIG. 4 is an exploded view of an optional dovetail assembly of one embodiment of the invention; and

FIG. 5 is a front view on one embodiment of the invention showing one row of windows having optional vertical and horizontal muntins.

### DETAILED DESCRIPTION OF THE INVENTION

For toys that cannot be easily displayed in the opening, detachable display units can be affixed in one or more of the openings. The detachable display units can be mounted to the openings through any number of mechanical fastening means well known in the art. The detachable storage units can include but not be limited to a flat shelf-like panel, a flat shelf-like panel with sides, or an enclosed cube having single opening along one side which mates with the particular opening to which it is attached. The toy storage device of the present invention can come with one or more of the openings having the display unit permanently attached.

Though reference will be made in this application to storing and displaying stuffed animals, it should be noted that any type of article, toy, stuffed animal, doll, action figure, model cars and the like can be stored and displayed within the instant invention.

### DETAILED DESCRIPTION OF THE INVENTION

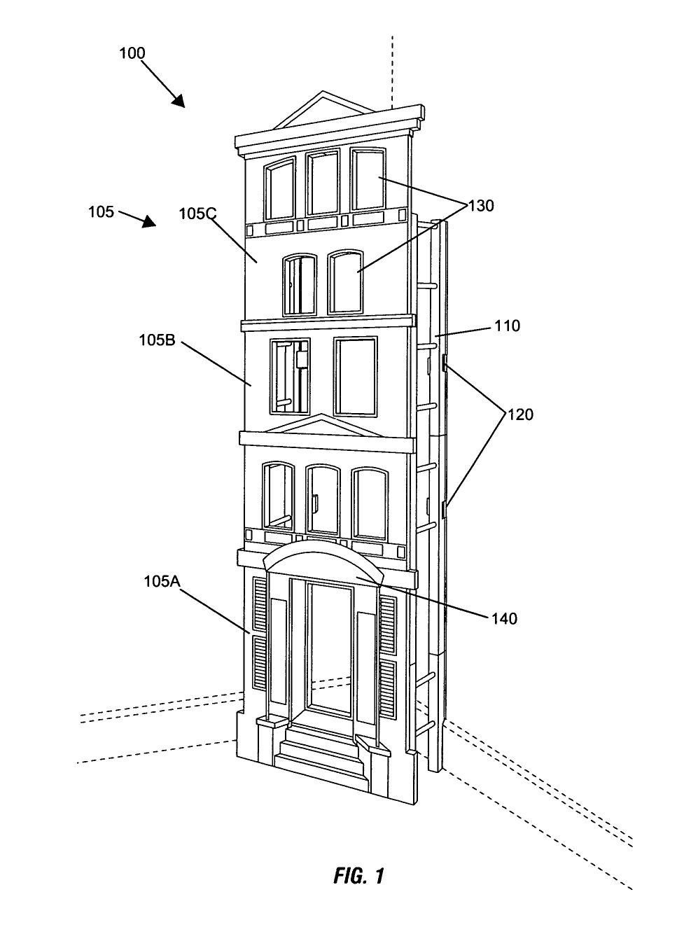

A perspective view of Storage Device 100 mounted in a corner is shown in FIG. 1. Front Panel Assembly 105 is made up of three panels: Lower Front Panel 105A, Middle Front Panel 105B and Top Front Panel 105C. Though Front Panel Assembly 105 is shown here as being composed of three smaller pieces, primarily for packaging and shipping efficiency, Front Panel Assembly 105 can be composed of a single panel or any number of sub-panels.

Front Panel Assembly 105 has one or more Openings 130 within the one or more of the sub panels. Openings 130 permit stuffed animals to be inserted behind the Front Panel Assembly 105. Openings 130 have an area of about 15 square inches or more.

Front Panel Assembly 105 can have various indicia disposed on its front surface. Various themes can be used based upon the intended users. Such themes can include space travel, auto racing, and cowboys for boys and ballerinas, fashion shows and tea parties for the girls.

A Right Side Panel 110 and a Left Side Panel 115 are shown attached to the left and right sides of the Front Panel Assembly 105. Though the Side Panels 110 and 115 are shown mounted at right angles to the Front Panel Assembly 105, the Side Panels 110 and 115 can be mounted at any reasonable angle with respect Front Panel 105.

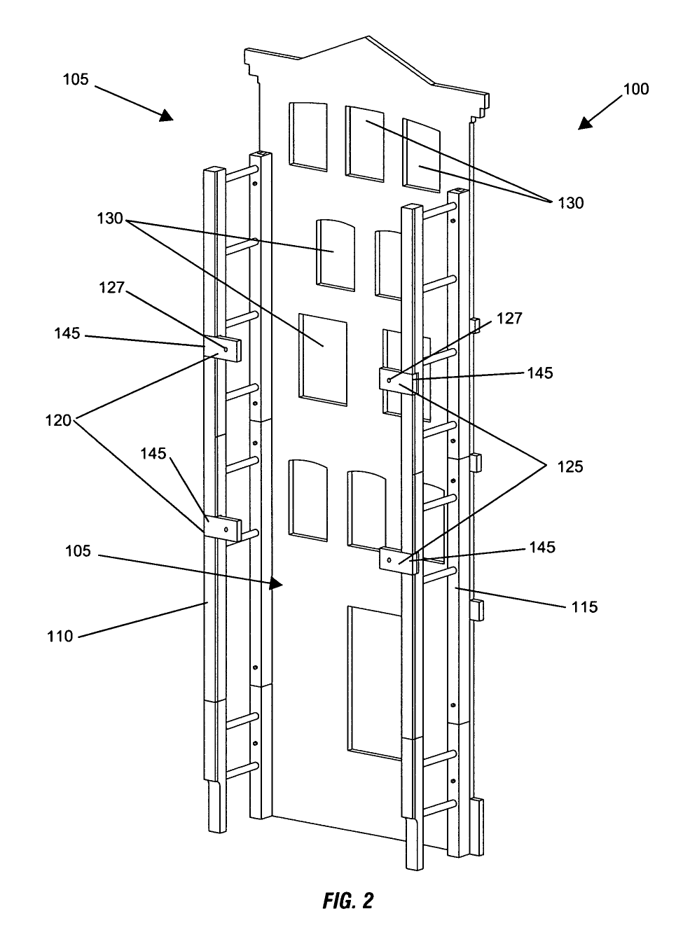

The Right and Left Side Panels can have a fairly open structure as shown in FIG. 2 or be constructed with a more closed structure. The open structure of Right and Left Side Panels permit stuffed animals to be positioned and displayed within these openings.

Incorporated in Right Side Panel 110 are one or more Right Attachment Blocks 120 and incorporated in Left Side Panel 115 are one or more Left Attachment Blocks 125. The Attachment Blocks 120 and 125 are hinge-like blocks which can be rotated about Pivot Points 145 with respect to their respective Side Walls.

This allows Storage Device 100 to be mounted along a flat wall, i.e. Front Panel Assembly 105 is mounted generally parallel to the flat wall by positioning the Attachment Blocks at right angles to the general plane of the Side Walls.

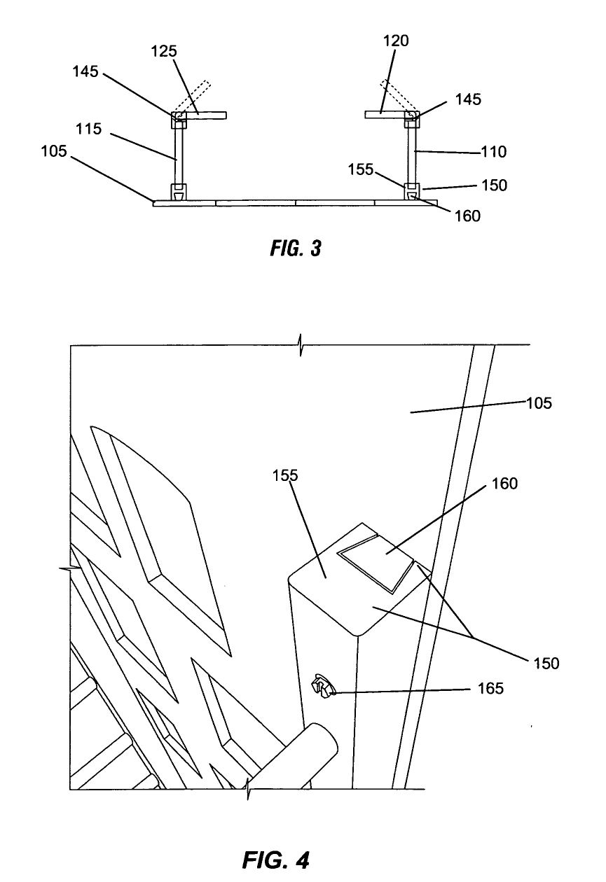

If the Attachment Blocks 120 and 125 are positioned at about 135 degrees with respect to their attached Side Walls, as shown in dashed lines in FIG. 3, then Storage Device 100 can be mounted in a corner, i.e. the Front Panel Assembly 105 is positioned at about 45 degrees with respect to the two side walls forming the corner.

The Right and Left Attachment Blocks 120 and 125 have incorporated therein Mounting Holes 127. Any of a variety of standard mechanical fasteners can be inserted through Mounting Holes 127 to attach Toy Storage Device 100 to the walls or walls.

When Toy Storage Device 100 is mounted in a corner or against a wall, the Front Panel, and the Side Walls form a more or less enclosed storage space with the one or more walls and the floor.

Typically, Storage Device 100 will be mounted so that the Front Panel Assembly is touching so that it touches the floor, carpet or other surface. However, Storage Device 100 could be mounted as any distance over the surface, so long as the toys that are stored with in are large enough to be effectively retained with the enclosed space formed by the Front Panel Assembly 105 and the two Side Panels.

In addition, though shown without an upper enclosing ceiling-like panel, Storage Device 100 could include such a panel so that the only access to the enclosed space is through the openings within the Front Panel Assembly 105.

As shown in FIG. 4, When Front Panel Assembly 105 is composed of sub panels they are formed into a single panel by way of a Sliding Dovetail Assembly 150 composed of First Part 155 and Second Part 160. Each of the sub panels of Front Panel Assembly 105 has a length of Second Part 160 attached to each side of the back surface of the sub panel. Each of the Side Walls has a length of First Part 155 which has length such that when it engages the Second Part 160 it extends past one of the sub panels and engages the upper portion of the Second Part 160 on the sub panel immediately below. When both Side Walls are properly engaged, all sub panels of Front Panel Assembly 105 are fixed to each other forming a secure panel. To provide further rigidity, one or more Fasteners 165 can be used to firmly attached First Part 155 to Second Part 160 at various points along the lengths for Dovetail Assembly 150.

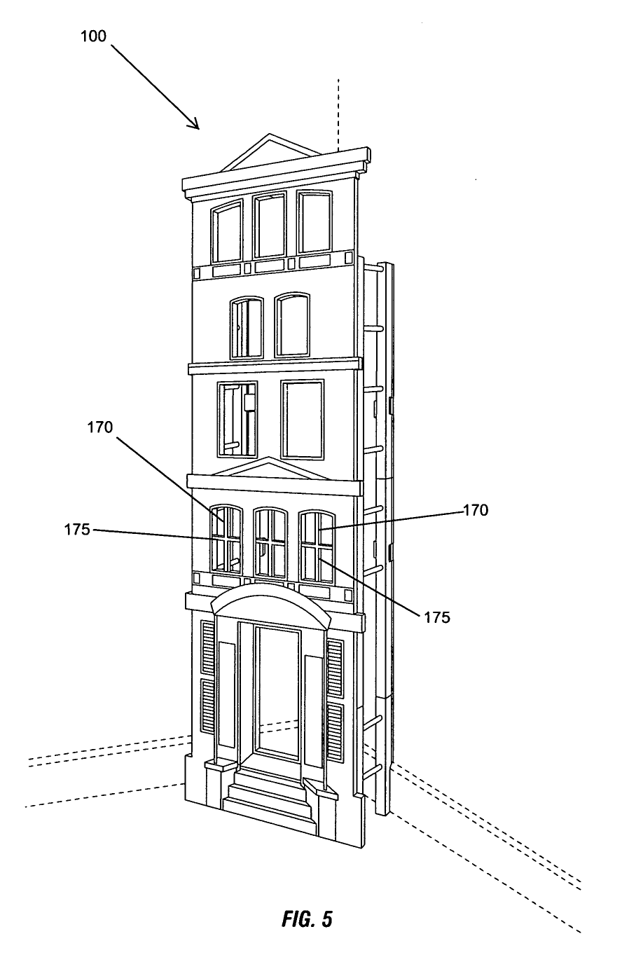

In the interest of safety for small children, two additional features may optionally be included in the invention which are shown in FIG. 5. The windows on the second level or higher can be fitted with both one or more Vertical Muntins 170 and one or more Horizontal Muntins 175 to reduce the chance a child getting lodged within the window. As used herein, windows generally refers to openings placed higher than the lowest level opening which is usually decorated to appear as a door. The Muntins shall be place show that no opening in any window shall be large than 3.4″×8.0 inches. The second option is to limit the size of any window to no more than 3.4 inches by 6.0 inches.

By use of component assemblies, the Toy Storage Device 100 can be packaged within a storage and/or shipping container have a volume of about 2.2 cubic feet or less.

While the invention has been described in conjunction with the preferred specific embodiments thereof, it is to be understood that the foregoing description as well as the examples are intended to illustrate and not limit the scope of the invention. Other aspects, advantages and modifications within the scope of the invention will be apparent to those skilled in the art to which the invention pertains.

What is claimed is:

1. An article of manufacture comprising:
a. a front panel;
b. a support means for attaching said front panel to at least one mounting surface;
c. said support means adapted to position said front panel in close proximity to a lower surface; wherein said support means, said front panel, said lower surface and at said at least one mounting surface define an enclosed volume;
d. said front panel further comprising at least one opening through the front panel wherein one or more objects can be inserted through said at least one opening and retained within said enclosed volume.

2. An article as described in claim 1 wherein said front panel is essentially planar.

3. An article as described in claim 2 wherein said front panel further comprises indicia.

4. An article as described in claim 1 wherein said one or more openings have an area of at least about 15 square inches.

5. An article of manufacture as described in claim 1 where said support means is adapted to mount said front panel to two mounting surfaces.

6. An article of manufacture as described in claim 5 wherein said two mounting surfaces form an essentially right angle.

7. An article of manufacture as described in claim 1 wherein said support means is adapted to mount said front panel to a single flat mounting surface.

8. An article of manufacture as described in claim 1 wherein said support means is adapted to mount said front panel to both a single mounting surface and to two mounting surfaces.

9. An article of manufacture as described in claim 1 further comprising a display means disposed within one or more of said openings.

10. An article of manufacture as described in claim 9, wherein said display means is detachable.

11. A kit comprising a plurality of components that can be assembled to form an article of manufacture as described in claim 1.

12. A kit as described in claim 11 wherein said kit can be placed in a container having a volume of about 2.2 cubic feet of less.

13. An article as described in claim 4 wherein said one or more openings have an size of no more than about 3.4 inches by about 6.0 inches.

14. An article as described in claim 1 wherein at least one of said one or more openings are fitted with at least one or more vertical muntin or horizontal muntins wherein the openings the muntins form within the openings have a size of no more than 3.4 inches and no more than 6.0 inches.
